(19) United States
(12) Patent Application Publication
(10) Pub. No.: US 2015/0105035 A1
(43) Pub. Date: Apr. 16, 2015

(54) Web-Connected Safety Helmet

(71) Applicant: Eduardo Soares de OLIVEIRA, Sao Paulo (BR)

(72) Inventor: Eduardo Soares de Oliveira, Sao Paulo (BR)

(21) Appl. No.: 14/391,798

(22) PCT Filed: Apr. 11, 2013
(86) PCT No.: PCT/BR2013/000115

§ 371 Date: Oct. 10, 2014

(30) Foreign Application Priority Data
Apr. 13, 2012 (BR) BR 20 2012 008702
Dec. 4, 2012 (BR) 10 2012 030877

(51) Int. Cl. H04B 1/3827; H04B 5/00; H04N 5/225; A42B 3/30; H04W 88/02

(52) U.S. Cl. CPC H04B 1/3827; A42B 3/30; H04W 88/02; H04N 5/225; H04B 5/0031
USPC 455/90.3

(57) ABSTRACT

The present invention relates to a new safety helmet, developed in particular to be used by cyclists, motorcyclists, sportsmen in general or in any conditions requiring the use thereof, that is to say, circumstances in which user safety must be ensured, or just for promoting and facilitating conversations with other persons. The safety helmet is capable of displaying itineraries by GPS, capturing information, images or scenes during an excursion or posting images, videos and comments on social networks. The web-connected safety helmet (CS) operates in two different modes, that is to say, via a wi-fi connection to a mobile device with an application designed for that purpose, or with a direct 3G or 4G connection to the web, without the need of any other device or application.

### CROSS REFERENCE TO RELATED APPLICATIONS

This application is a national stage of PCT International Patent Application no. PCT/BR2013/000115, filed 13 Apr. 2013, which claimed priority in Brazillian patent application nos. BR 20 2012 008702-8, filed 13 Apr. 2012 and BR 10 2012 030877-0, filed 4 Dec. 2012, the contents of these applications being incorporated by reference herein.

### FIELD OF INVENTION

The present invention relates to a new safety helmet, developed in particular to be used by cyclists, motorcyclists, sportsmen in general or in any conditions requiring the use thereof, that is to say, circumstances in which user safety must be ensured, or just for promoting and facilitating conversations with other persons, showing itineraries by GPS, capturing information, images or scenes during an excursion, posting images, videos and comments on social networks. The safety helmet belongs particularly to the field of safety helmets provided with data communication and transmitting systems, designed to promote easy communication for the user during a bicycle or motorcycle ride, or during any sport practice that demands a protection helmet, having constructive and functional aspects that provide the user with a series of new benefits to the end of which it is intended.

### STATE OF THE ART

As widely known by industry and trade professionals of protective helmets for motorcycle and bicycle users, besides professionals involved in the production and marketing of helmets designed for the practice of sports, many models of helmets are provided whose functional characteristics extend beyond the protection of the user.

Correspondingly, the prior art reveals several models of helmets, among which a type of helmet should be emphasize that provides an embedded system for audio transmission, this document being filed at the INPI under number PI0404701-0 at Aug. 27, 2004 and that discloses a speakerphone system for a motorcycle helmet, the system comprising a headset, a microphone interconnected to the device by a connection chip, providing the necessary condition for a satisfactory telephone service, even during the movement of the motorcycle.

This document discloses only the application of a headphone and a microphone, interconnected by a chip, to enable the user of the helmet to answer a cell phone call.

Another document, PI0500777-1 of Mar. 7, 2005, discloses a helmet equipped with a place to insert a SIM card, in addition to headphones and microphones to enable communication via a cell phone, and a MP3 player coupled to said helmet.

Another document M314495 of Jun. 21, 2007 discloses the application of a headset and a microphone, enabling communication via a cell phone to the user of the helmet.

Additionally to these documents, another document is provided and indicates the application of a headset, a microphone and a camera, this document filed under the number CN 201139106 on Nov. 26, 2007, enabling communication via a cell phone to the user of the helmet, and to run a film footage that can be transported through a cable to a microcomputer.

Other documents of helmets with a more advanced form and functional structure describe the possibility of wireless transmission of data, subject matter disclosed in document PI0801299-7 filed on Apr. 11, 2008, which discloses a helmet for motorcycle drivers provided with sensors that prevent the operation of the motorcycle when the helmet is not being used, increasing the safety.

The document CN1866755, filed on May 18, 2005, discloses a set of elements that enable wireless communication for the transfer and/or transmission of images and video, which includes image control, remote processing and wireless measurement service.

In the state of the art there is also provided a document filed under number CN201928272 on Dec. 8, 2010, which discloses a wireless transmission system developed for the transmission of vital signals of mining professionals, comprising a digital pulse sensor in which an impulse output terminal of the digital pulse signal sensor is connected to an impulse signal input terminal of a microprocessor, and an output signal transmission terminal of the microprocessor is connected to an input signal transmission terminal of the wireless transmission module.

As can be observed in prior art documents found at the major patents banks of the world, some documents only apply to communication means via a cell phone without the need to remove the helmet to make or receive cellular phone calls.

Other documents provide means for capturing images and videos through embedded or not embedded cameras applied in the helmet, images that may be transported through a transmission cable to a microcomputer.

Additionally, some other documents found also disclose helmets capable of transmitting information through a wireless system.

### SUMMARY OF THE INVENTION

Considering these drawbacks and interested in providing enhancements for the consumer public, the inventor has created and developed a web connected safety helmet which should position itself with full prominence among its counterparts and customize itself for the consumer market by the fact of presenting a safety helmet, developed to be used by cyclists, motorcyclists, sportsmen in general or in any conditions requiring the use thereof, that is to say, circumstances in which user safety must be ensured, or just for promoting and facilitating conversations with other persons, showing itinerary indications by GPS, capturing information, images or scenes during an excursion, as well as posting images, videos and comments on social networks, said safety and protection helmet comprising constructive and functional aspects that provide more benefits to the user.

The safety helmet is connected to the WEB and equipped with an IP in its transmission system of data, sounds, images and videos, also providing other complementary equipment, as well as wi-fi communications with any mobile device through a specific application developed for this purpose.

This transmission system also features a private access point, which is obtained through a 3G connection, and consequently, the application creates a private access point of the wi-fi network through which the data transmission is realized in 2 routes.

With this structure, the user can shoot, record and deliver, via IP, all the content captured by the helmet in real time.

Additionally, through the 3G connection, the application synchronizes all collected information with a web server and social networks, and consequently, the user has full access to the information via the application or a web browser.

### BRIEF DESCRIPTION OF THE DRAWINGS

The subject matter of this invention will become fully clear in its technical aspects from the detailed description that will be made based on the figures listed below, in which:

FIG. 1 shows a side view of a user using the safety helmet with web connection; and

FIG. 2 shows a schematic view of the component parts of the safety helmet assembly with web connection.

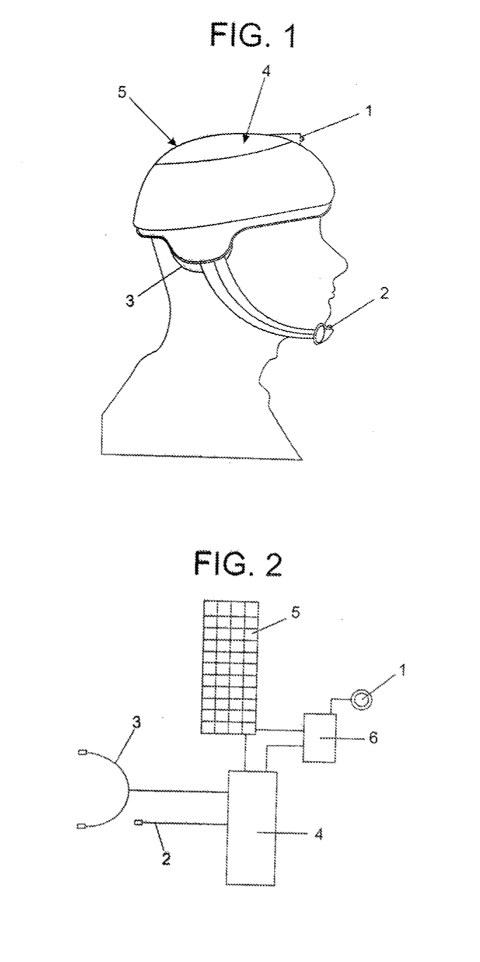

### DETAILED DESCRIPTION OF THE INVENTION

According to the illustrations of above figures, the present invention is a web-connected safety helmet which is a safety helmet CS, designed to be used by cyclists, motorcyclists, sportsmen in general or in any conditions requiring the use thereof, that is to say, circumstances in which user safety must be ensured, or just for promoting and facilitating conversations with other persons, showing itinerary indications by GPS, capturing information, images or scenes during an excursion, making check-ins via voice, find people, places and establishments through geolocation, get suggestions of paths, mileage information, speed, timing, time, calorie burning, listening to music, answering a call or even posting images, videos and comments on social networks, said safety and protection helmet having constructive and functional aspects that provide more benefits to the user.

The safety helmet CS is connected to the WEB and equipped with a motherboard 4 containing an embedded operating system, inputs for GPS, Bluetooth, GSM for 3G/4G chips, headphones 3, microphone 2 and flash memory; a processor 6 for IPcam 1 and a IPcam 1 in its transmission system for data, sounds, images and videos, also providing a wi-fi antenna for data transmission (audio and video), and a lithium battery or photovoltaic plate 5 to charge the devices, and it communicates via wi-fi with any mobile device through a specific application developed for this purpose.

This transmission system also features a private access point, which is obtained through a 3G connection, and consequently, the application creates a private access point of the wi-fi network through which the data transmission is realized in 2 routes.

With this structure, the user can shoot, record and deliver, via IP, all the content captured by the helmet CS in real time.

Additionally, via a 3G connection, the application synchronizes all collected data with a web server and social networks, and consequently, the user has full access to the information via the application or web browser.

All command instructions from the application to the helmet are made by voice or a trigger device connected to the mobile device,

The activation of the telephone, the social networks and the internet, and the activation of the GPS via voice commands and the data reception from these devices also by voice commands, are functions captured and processed by the application used in this system.

The user, when purchasing the safety helmet with web connection, makes a registration at the helmet supplier company, or at the moment he downloads the application to his cell phone, and this process creates a profile and a registration barcode of the helmet he acquired and entitles the user to become a member of the product supply network.

Through the control panel, provided in the user profile, either through the website or the application, the user may configure the way in which the helmet CS should work, that is, in an automatic mode, in which all information is shared and the camera works live, or in a custom mode, that is, via customized sharing options, and finally, to work online or offline if the user just wants to record the path directly in the flash memory of the helmet itself.

The web-connected safety helmet CS consists of a motherboard 4 containing an embedded operating system, with inputs for GPS, Bluetooth, GSM for 3G/4G chips, headphones, microphone 2 and flash memory. A processor 6 for IPcam 1 and a IPcam 1 in its transmission system for data, sounds, images and videos, also providing a wi-fi antenna for data communication (audio and video), and a lithium battery or photovoltaic plate to charge the devices.

The operation of the web-connected safety helmet CS takes place in two distinctive ways, namely, via wi-fi with any mobile device through a developed application, or directly with the web through a 3G/4G connection without the need of any other device or application.

In the first option, the helmet CS communicates via wi-fi with any mobile device through an application developed for this purpose.

Through a 3G/4G connection, the application creates a private access point of the wi-fi network through which the data transmission is realized in two routes.

All command instructions from the application to the helmet are made by voice.

The user may record and provide via IP, all content captured by the helmet CS camera in real time.

Through a 3G/4G connection the application synchronizes all collected data with a web server and shares it on social networks, and may even record the images on the server or on the cellphone itself, or in case of signal loss, store it in the helmet flash memory.

In addition to filming and recording the route with the camera, the user may take pictures, use the GPS via headphones 3, make check-ins via voice, discover people, places and establishments through geolocation, get suggestions of routes, information of mileage, speed, timing, time, calorie burning, listen to music, answer a call and still share all in real time through the website or the social networks without taking his hands of the handlebars or losing focus on the route.

In the second operation option, the helmet CS communicates and synchronizes the data directly with the web via a 3G/4G connection, without the need of any other device or application.

All control commands for the helmet CS are made by voice and processed directly on the motherboard 4.

The user may choose to purchase the helmet CS and use his own 3G/4G data plan and own server to store the collected data, or as an alternatively, hire a service from the helmet CS manufacturer, due to its high performance capacity and storage.

The set of helmet CS and equipment applied to it provides sharing information in social media, and also acts as a record of the various events that may occur with the cyclist/motorcyclist/athlete during the course and/or activity, that is, a transgression of a driver, accidents and assaults, among other events that may be subjected to further analysis and information detection for investigation.

In addition to protect the user's head, the safety helmet CS may also be used as a means for real time communication, producing information that is likely to be a black box for its users, and besides producing, transmitting and receiving pictures, videos and other files in real time, it shows how people interrelate with the environment when riding a bike, driving a motorcycle or practicing any sport that requires the use of a safety helmet.

The user of the helmet CS has full access to all information generated, sent and/or received through the mobile application, web browser, flash memory or the cellphone memory.

The users, registered or not registered at the helmet manufacturer, will have access only to the information that the helmet user defines as a material to be shared.

Although the detailed description of the present invention, it is important to understand that it does not limit its application to the details and steps herein described. The invention is capable of other embodiments and of being practiced or carried out in a variety of ways. It should be understood that the terminology used herein has the purpose of description and not of limitation.

1-17. (canceled)

18. A web-connected safety helmet comprising:
a safety helmet adapted for connecting to the world-wide web (internet);
a motherboard incorporated with the safety helmet and containing an embedded operating system;
inputs selected from the group consisting of a global positioning system (GPS) input, a near field wireless communication (Bluetooth) input, a global system for mobile communication (GSM) chip input, headphones input, a microphone input, a flash memory input and combinations thereof;
a processor for a network IP camera (IPCam);
a network IP Camera;
a transmission system for transmitting data, sounds, images and videos;
a wi-fi antenna adapted for audio and video data transmission;
an application adapted for communicating via wi-fi with a mobile device, and,
a battery for powering the safety helmet and optionally a photovoltaic device for charging the battery.

19. The safety helmet according to claim 18 wherein the photovoltaic device is a photovoltaic plate.

20. The safety helmet according to claim 18 wherein the transmission system has a private access point, which is obtained through a GSM connection, the application creating a private access point on a wi-fi network through which data transmission is realized via two routes.

21. The safety helmet according to claim 18 wherein the application is configured to synchronize all information collected from the safety helmet inputs and devices with a web server and social networks, a user having full access to the information via the application or via a web browser.

22. The safety Helmet according to claim 18 wherein command instructions for the inputs and safety helmet associated devices are delivered to the safety helmet by voice or a trigger device connected to the mobile device.

23. The safety Helmet according to claim 18 further comprising a registration system for providing access to the application, such that a user may register the safety helmet, download the application to a mobile device, create a profile and submit a registration code of the safety helmet, to allow the user, to access a control panel provided on the profile, for configuring the way in which the safety helmet will operate.

24. The safety helmet according to claim 18 wherein the safety helmet is configured for operating in an automatic mode, in which all information is automatically shared and the camera provides a live transmission.

25. The safety helmet according to claim 18 wherein the safety helmet is configured for operating in a custom mode, configured via user customized sharing options.

26. The safety helmet according to claim 18 wherein the safety helmet is operable online or offline, such that a user can collect and store information directly in a flash memory provided in the safety helmet.

27. The safety helmet according to claim 18 wherein the safety helmet communicates via a wi-fi network with the mobile device through a developed application.

28. The safety helmet according to claim 18 wherein operation of the devices and inputs associated with the safety helmet takes place directly and exclusively through the internet via a 3G or 4G GSM connection.

29. The safety helmet according to claim 18 wherein the safety helmet establishes communication via a 3G or 4G GSM connection, the application creating a private access point on a wi-fi network through which data transmission is realized via two routes, either directly through a web connection or through an application on the mobile device.

30. The safety helmet according to claim 18 wherein voice commands for operating the devices and inputs associated with the safety helmet are made to the safety helmet and processed directly by the motherboard.

31. The safety helmet according to claim 18 wherein a user may record and make available via the internet, all content captured by the camera in real time.

32. The safety helmet according to claim 18 wherein the safety helmet establishes communication via a 3G or 4G GSM connection, the application is configured to synchronize all information collected from the safety helmet inputs and devices with a web server and social networks, the application being configured to record images on the web server or on the mobile device, or in case of a signal loss, to store the information in a flash memory.

33. The safety helmet according to claim 18 wherein a user may obtain a 3G or 4G GSM data plan and designate a personal server for storing the safety helmet collected data.

34. The safety helmet according to claim 18 wherein the safety helmet is configured to provide a user with full access to all information generated, sent and/or received through a mobile application, web browser, flash memory or a cell phone memory.
